(19) United States
(12) Patent Application Publication
(10) Pub. No.: US 2026/0210913 A1
(43) Pub. Date: Jul. 23, 2026

(54) AUTONOMOUS ROBOT WITH TELESCOPIC ARM FOR CONTACT-BASED INTERNAL INSPECTION OF UNDERGROUND TANKS

(71) Applicant: SAUDI ARABIAN OIL COMPANY, Dhahran (SA)

(72) Inventors: Fadl Abdellatif, Thuwal (SA); Yousef Damanhouri, Thuwal (SA); Ali Alshehri, Thuwal (SA); Ibrahim S. Alsalamah, Thuwal (SA); Ali Alrasheed, Thuwal (SA); Rami AlSulaim, Al-Khobar (SA); Mohammad Almajed, Dhahran (SA)

(73) Assignee: SAUDI ARABIAN OIL COMPANY, Dhahran (SA)

(21) Appl. No.: 19/027,585

(22) Filed: Jan. 17, 2025

(51) Int. Cl. G01N 29/265; B25J 9/10; B25J 18/02; B62D 53/00; G01B 17/02; G01N 29/04

(52) U.S. Cl. CPC G01N 29/265; B25J 9/104; B25J 18/025; B62D 53/00; G01B 17/02; G01N 29/04; G01N 2291/0234; G01N 2291/02854; G01N 2291/0289; G01N 2291/106

(57) ABSTRACT

An autonomous system for inspecting an underground tank includes an unmanned ground vehicle (UGV) that is configured to drive along an inner wall of the underground tank. The system includes a motorized telescopic pole that is movably attached at a first end to the UGV. The system further includes a multi sensor array that is movably attached to an opposite second end of the telescopic pole, the multi sensor array comprising a plurality of sensors for inspecting the inner wall of the underground tank.

### TECHNICAL FIELD

The present technology is generally related to underground inspection technology and, more particularly to a system compromised of an unmanned ground vehicle (UGV) equipped with a telescopic pole with a multi sensor array installed on its end. The system provides the ability to conduct the inspection process autonomously, covering a wide area, which allows the duration to be reduced significantly.

### BACKGROUND

Cavern tanks are large underground tanks used for storage of hydrocarbon products. It is important to periodically inspect the structural integrity of the tank walls in order to prevent failures and unplanned shutdowns. Due to their large volume, inspecting the expansive tank wall surfaces requires a lot of time and effort. The internal structure of the underground tank can vary; however, they can be tens of meters wide and high, and hundreds of meters long. For example, the tank can be taller than it is wide and can have an arcuate shaped roof. There is typically one or more access points that allow entry to the tank once it is emptied.

Inspection of these tank walls is currently done from inside by erecting scaffolding throughout the internal volume of the tank, allowing of manual inspection to be done for the whole tank surface including the roof. This process is extremely time consuming due to the time it takes to build the scaffolding as well as the time to transport the scaffolding material in and out of the tank. This makes inspection very costly and dangerous due to falling hazard.

Various types of inspection are done but they mainly revolve around: visual inspection (photos), thickness measurements using UT probes, crack inspection, and coating inspection.

There is therefore a need to provide the ability to conduct the inspection process autonomously, covering a wide area, which allows the duration to be reduced significantly.

### SUMMARY OF THE DISCLOSURE

In accordance with one embodiment, an autonomous system for inspecting an underground tank includes an unmanned ground vehicle (UGV) that is configured to drive along an inner wall of the underground tank. The system includes a motorized telescopic pole that is movably attached at a first end to the UGV. The system further includes a multi sensor array that is movably attached to an opposite second end of the telescopic pole, the multi sensor array comprising a plurality of sensors for inspecting the inner wall of the underground tank.

### BRIEF DESCRIPTION OF THE DRAWINGS

The disclosure can be more completely understood in consideration of the following detailed description of various embodiments of the disclosure, in connection with the accompanying drawings, in which:

FIG. 1 a cross-sectional view of an exemplary cavern tank;

FIG. 2 is a side perspective view of an autonomous inspection system including an unmanned ground vehicle for inspecting an underground cavity, such as a cavern tank, according to a first embodiment;

FIG. 3 is a side view of the autonomous inspection system with a telescopic pole in extended position and pivoted relative to the unmanned ground vehicle to which the pole is coupled;

FIG. 4 is a perspective closeup view of a swivel joint multi sensor array;

FIG. 5 is a side view of an autonomous inspection system including an unmanned ground vehicle for inspecting an underground cavity, such as a cavern tank, according to a second embodiment;

FIG. 6 is a perspective closeup view of a multi-directional sensor array;

FIG. 7 is a side perspective view of an autonomous inspection system including an unmanned ground vehicle for inspecting an underground cavity, such as a cavern tank, according to a third embodiment;

FIG. 8 is a perspective closeup view of a cable driven joint mechanism;

FIG. 9 a side perspective view of an autonomous inspection system including an unmanned ground vehicle for inspecting an underground cavity, such as a cavern tank, according to a fourth embodiment;

FIG. 10 is a top plan view thereof;

FIG. 11 is a perspective view of a multi sensor array with magnetic roller for use in an autonomous inspection system including an unmanned ground vehicle for inspecting an underground cavity, such as a cavern tank, according to a fifth embodiment;

FIG. 12 is a top plan view thereof;

FIGS. 13A and 13B are side views of an autonomous inspection system including a base station for inspecting an underground cavity, such as a cavern tank, according to a sixth embodiment;

FIG. 14 is a perspective view a side perspective view of an autonomous inspection system including an unmanned ground vehicle for inspecting an underground cavity, such as a cavern tank, according to a seventh embodiment;

FIG. 15 is a side view thereof;

FIG. 16 is a side view of a branched telescopic pole with multiple scanning heads for use in an autonomous inspection system including an unmanned ground vehicle for inspecting an underground cavity, such as a cavern tank, according to an eighth embodiment;

FIG. 17 is a top view of an autonomous inspection system including an unmanned aerial vehicle for inspecting an underground cavity, such as a cavern tank, according to a ninth embodiment; and

FIG. 18 is a side view thereof.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

FIG. 1 illustrates an exemplary underground tank 10 used for storage of hydrocarbon products. The internal structure of the underground tank 10, also known as a cavern tank, can vary; however, they can be tens of meters wide and high, and hundreds of meters long. There is typically one or more access points that allow entry to the tank once it is emptied.

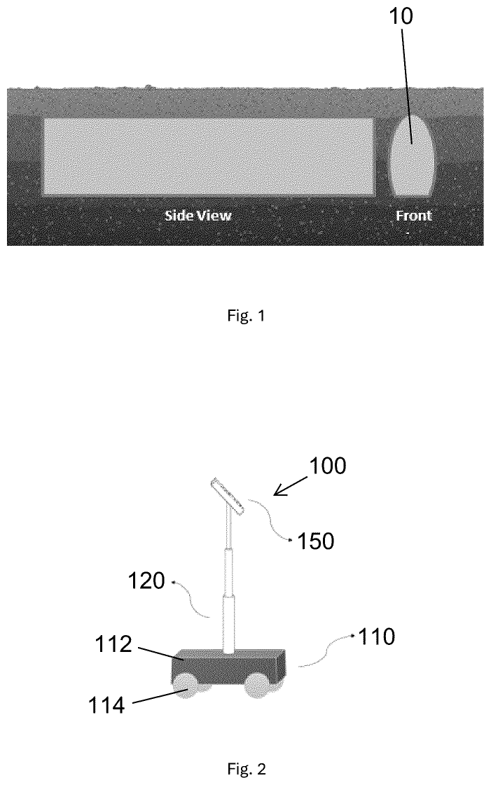

As set forth herein, FIGS. 2-4 illustrate an autonomous inspection system 100 in accordance with one embodiment of the present disclosure. More specifically, the autonomous inspection system 100 includes an unmanned ground vehicle (UGV) 110 that includes a motorized telescopic pole 120 and a multi sensor array 150. As discussed herein, the system 100 provides a solution and a method that performs rapid scanning for the entire wall surface in order to obtain a full corrosion map quickly in a timely manner. FIG. 1 is a simple representation of one system 100.

As previously mentioned, cavern tanks are large underground structures that hold product for long periods of time. The structure must go through periodic inspection to visually check the structural and coating integrity inside the tank. Due to the sheer size of the structure utilizing the unmanned ground vehicle (UGV) 110 eliminates the installation of scaffolding which, as mentioned, is time consuming and costly.

The system 100 employs a contact-based inspection process that utilizes the telescopic pole 120 equipped with multiple sensors (multi sensor array 150) and technologies for (non-destructive testing) NDT testing.

As set forth herein, the multi sensor array 150 can include one or more sensors 151 (FIG. 4) that are selected from the group consisting of:
1. Array of UT transducers: In the preferred embodiment the head includes a number of UT (ultrasonic thickness) transducers in 2 interlaced horizontal arrays with some overlap to ensure full coverage. The array can measure the thickness of not only one spot but a full line that spans the width of the vehicle. Once the vehicle drives forward, a 2D thickness scan of the whole traversed area by the crawler can be obtained;
2. Phased array UT (PAUT);
3. Single UT transducer: using this requires an X-Y raster mechanism described later;
4. Holiday sensor to detect cracks in the coating over the steel wall;
5. Eddy current sensor or array of eddy current sensors to detect steel cracks;
6. EMAT for thickness measurements and crack detection;
7. TerraHertz inspection;
8. Magnetic particle inspection (MPI) for crack detection;
9. Magnetic Flux Leakage (MFL) for crack detection; and
10. LIDAR scanning to inspect deformations close-up to investigate possible stress/strain on the tank wall due to pressure from the surrounding soil.

It will be appreciated that the more than one type of sensor 151 can be and preferably is used as part of the multi sensor array 150.

The unmanned ground vehicle (UGV) 110 can comprise any number of suitable UGVs and can take many different forms. The UGV 110 is generally a driven structure that is motorized and is capable of driving in a controlled manner along inner surfaces within the cavern tanks. In the illustrated embodiment, the UGV 110 has a chassis or body 112 and a plurality of wheels 114 connected thereto. In the illustrated embodiment, the UGV has four wheels 114 and the chassis 112 houses operating components of the device, as well as communication equipment, etc. The UGV 110 is driven remotely by a person who is in proximity to the cavern tank. The communication equipment contains electronics, such as a main controller and communication equipment that allows control signals to be received wirelessly and processed for controlled driving of the UGV 110.

In general, as shown in FIG. 2, the telescopic pole 120 can be extended and contracted in a controlled manner so as to alter the length of the telescopic pole 120. By being able to control the length of the telescopic pole 120, the multi sensor array 150 that is carried at the distal end of the telescopic pole 120 can always be positioned into and remain in contact with the inner surface of the cavern tank. This telescopic action of the pole 120 allows the system 100 to be used in different shaped and different sized cavern tanks.

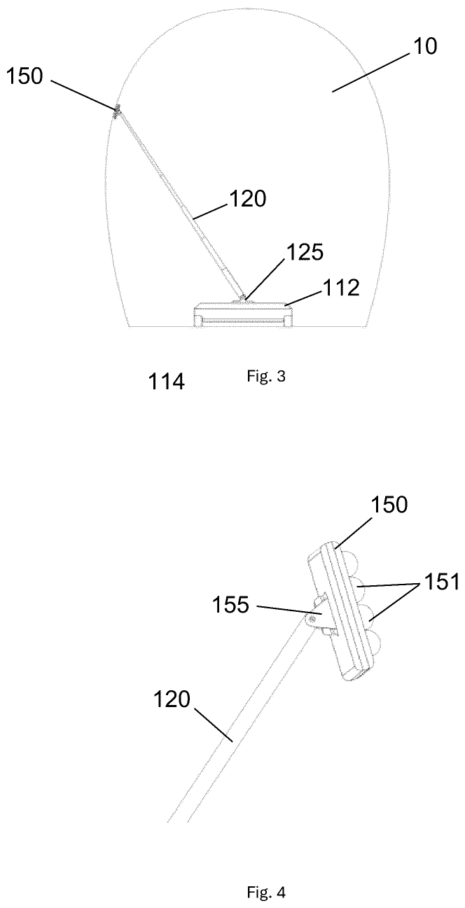

As shown in FIG. 3, the coupling or connection between a proximal end of the telescopic pole 120 and the chassis 112 is of a type that permits the telescopic pole 120 to move (pivot/swivel) in different directions. In FIG. 3, the connection between the telescopic pole 120 and the chassis 112 is represented by a swivel joint 125. In one embodiment, the swivel joint 125 allows for 180-degree motion of the telescopic pole 120.

The system 100 is capable of sweeping across the internal walls of the tank utilizing the swivel or multi jointed angel of the telescopic pole 120, allowing for different NDT inspections to find any areas of cracks, corrosion and areas without coating. Furthermore, eliminating the need of erecting scaffolding inside the cavern, reducing time it takes to carry out inspection as well as increasing safety.

This design of the system 100 allows for an easy method to overcome obstacles on the tank wall such as overhead pipes that run along the roof longitudinally. The telescopic arm 120 can be retracted upon reaching the obstacle and then expanded after the obstacle to continue the circumferential sweep. In addition, the UGV wheels 114 are magnetic which secures the UVG 110 to the floor of the cavern to avoid any tipping from the leverage of caused by the telescopic pole 120.

FIG. 3 illustrates how the first embodiment of the system 100 operates. The UGV 100 carries the telescopic pole and sensor array as it drives across the cavern. The first embodiment has a motorized swivel mechanism (e.g., swivel joint 125) which controls the tilt angle of the pole 120, while the telescopic pole 120 itself is motorized allowing it to change its length to the necessary height. The multi sensor array 150 makes contact with the surface of the cavern and sweeps across the circumference (this operating mode can be thought of as being a circumferential sweep mode). Once a full sweep is done, the UGV 110 moves further down across the cavern, repeating the sweeping process across the entire length of the cavern till a full scan of the cavern is obtained. The on-board electronics, including sensors 150, can detect when a full sweep of the wall is completed and then the UGV 110 incrementally moves to the new, next location where a new sweep is performed. The system 100 can include vision-based devices and sensors, such as onboard cameras, that allow the operator to view the site and also confirms that a full sweep has been accomplished. This type of system also allows the operator to view any obstructions, etc.

Due to the multi sensor array 150, readings are obtained to assess the cavern's health, detecting if there are any cracks, damage to the coating and overall structural integrity of the tank.

As shown, the sensors 151 can extend across the entire width of the sensor head.

As illustrated in FIG. 4, the sensor array 150 is attached to the telescopic pole by its own swivel joint 155. The swivel joint 155 allows for passive self-alignment against the cavern's surface during the sweep. In addition, the swivel joint 155 can be motorized to allow for an active alignment mechanism instead of a passive one. Either way, the sensor array 150 is designed to track and remain in contact with inner wall of the cavern tank as the telescopic pole 120 itself pivots with respect to the UGV 110. There are thus two pivot locations and more particularly, one pivot location is at one end of the telescopic pole 120 and the other pivot is at the other end of the telescopic pole 120.

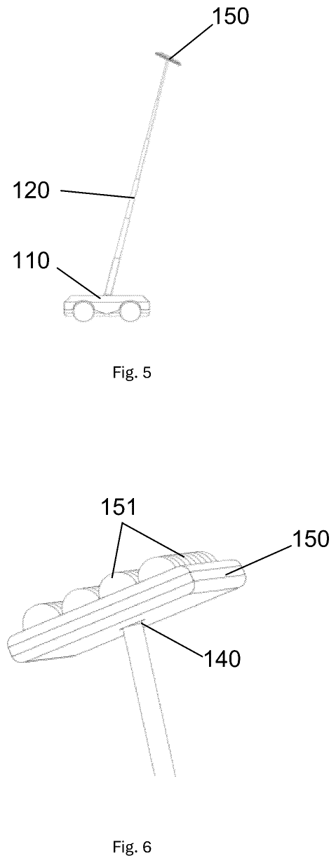

With reference to FIG. 5, in another embodiment, the system utilizes a multidirectional joint mechanism. More particularly, the multidirectional joint mechanism is motor driven which allows for the telescopic pole 120 to have the freedom to rotate in a 360-degree manner with respect to UGV 110, making both pan and tilt easy to perform, allowing the telescopic pole 120 and the sensor array 150 to cover a wider surface area when sweeping the tank surface. FIG. 6 illustrates that the multi sensor array 150 can be attached to the telescopic pole 120 via a multi-directional ball & joint mechanism, generically indicated at 140, allowing the multi sensor array 150 to move at rotational angles when attaching on and moving along the surface to be inspected. In other words, the multi sensor array 150 can freely rotate and pivot relative to the telescopic pole 120.

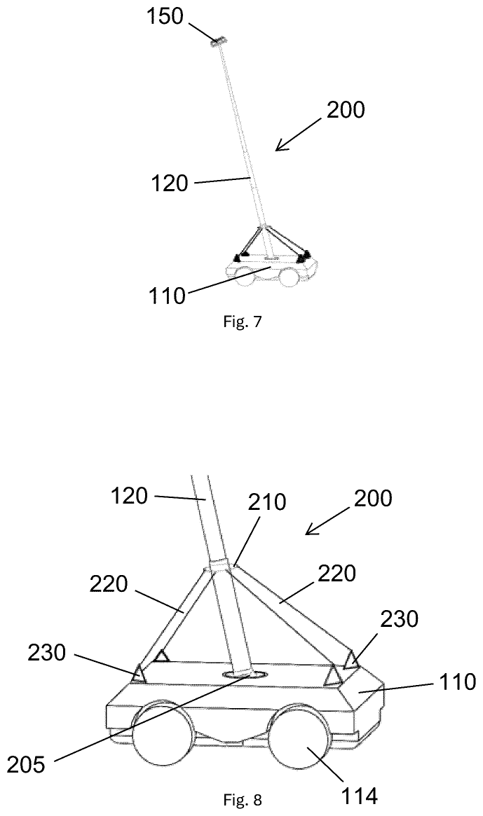

With reference to FIGS. 7 and 8, a system 200 according to another embodiment is shown and is directed to a cable driven multi-directional joint mechanism. The system 200 is similar to the previous systems described herein. In system 200, the telescopic pole 120 is controlled using a two degree of freedom pan and tilt mechanism. The pan and tilt mechanism operates by having a ring 210 connected to and surrounding the telescopic pole 120. The ring 210 has wires (cables) 220 attached thereto at different locations about the circumference of the ring 210. The opposite ends of these wires 220 are coupled to and routed through four motors 230 that are located on the chassis of the UGV 110. As shown, the four motors 230 can be located in four corners of the top surface of the chassis. The motors 230 work in sync to control the location of the telescopic pole 120. More specifically, since the wires 220 attach to four points (four locations) about the ring 210, when one respective wire is tightened and the other wires 220 loosen, the telescopic pole 120 moves in the direction of the tightening wire and corresponding motor 230. It will be appreciated that more than one wire 220 can be tightened at the same time and similarly, more than one wire 220 can be loosened at the same time.

In this embodiment, the movement of the telescopic pole 120 is dictated by either tightening or loosening the respective wire 220. This mechanism thus provides a two degree of freedom pan and tilt mechanism.

In addition, the proximal end of the pole 120 as shown in FIG. 8 is coupled to the UGV 110 with a joint, generally indicated at 205. This joint 205 can take may different suitable forms including a ball-in-socket type joint (i.e., a multidirectional joint).

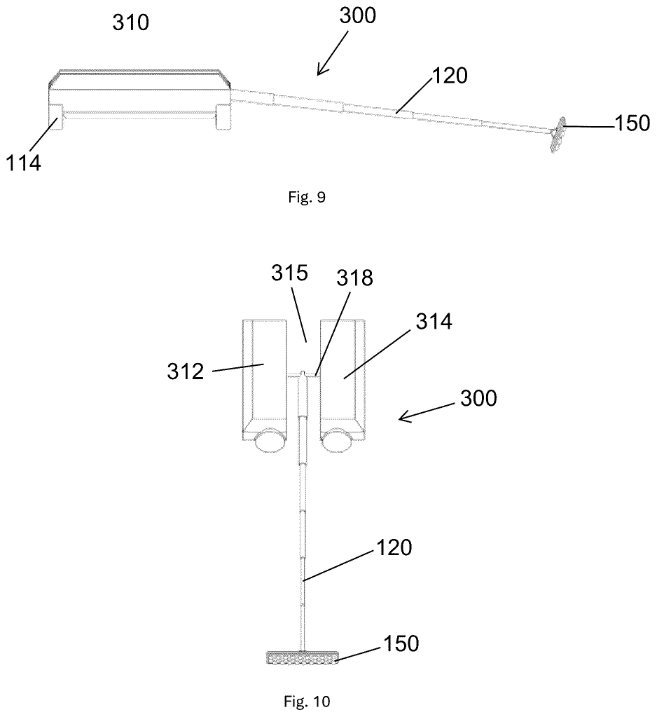

With reference to FIGS. 9 and 10, a system 300 according to another embodiment is shown and is generally in the form of a below horizon telescopic scanning mechanism. The system 300 is a modified design of the previous embodiments which utilize the swivel joint mechanism telescopic pole. However, in this embodiment, the system 300 has a UGV 310 that has a bifurcated design in that the UGV 310 is defined by a first body or chassis 312 and a second body or chassis 314. The two bodies 312, 314 are spaced apart with a space or gap 315 located therebetween. As shown, the two bodies 312, 314 are parallel to one another and can generally have a rectangular shape; however, other shapes are equally possible. Each body 312, 314 can carry an axle with two wheels 316 to allow for a controlled driving of the UGV 300.

In this embodiment, between the two bodies 312, 314, within the gap 315 there is a shaft 318 about which the telescopic pole 120 pivots. This shaft 318 is oriented perpendicular to the two bodies 312, 314. As in the other embodiments, the telescopic pole 120 carries the multi sensor array 150 in this embodiment.

Due to the splitting of the UGV body into two bodies 312, 314 and the lowered position of the shaft 318 (which is the pivot axis of the telescopic pole 120), the telescopic pole 120 has a greater angle of motion than the 180 degree range of motion of the first embodiment of FIG. 2. This increased pivot range allows the system 300 to scan below the UGV's horizon which gives access to a larger inspection area for the system 300 when conducting a sweeping action across the surface of the tank. This increased range can be appreciated by viewing the side elevation view of FIG. 9.

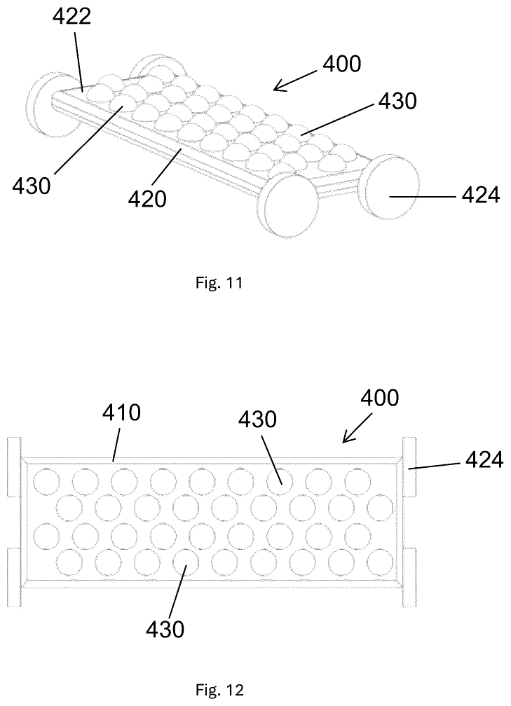

FIGS. 11-12 illustrate a system 400 according to another embodiment. In this embodiment, the system 400 utilizes a switchable magnetic roller/wheel, which allows the sensor array to be attached against the surface of the tank actively. In this system 400, the multi sensor array is thus part of a switchable magnetic roller/wheel device 410. The device 410 can include a main body (chassis) 420 that has a top surface 422 and includes a plurality of magnetic wheels 424 that allow the device 410 to attach to and be driven across a metal tank wall. Along the top surface 422 there is a plurality of sensors 430 that can be one or more of the sensors described previously with respect to the multi sensor array 150. The magnetic wheels 424 are sized and positioned so as to properly position the plurality of sensors 430 against or in close proximity to the tank surface to be inspected.

By using the magnetic roller (wheel device) 410, the inspection sweeping action (as a result of the sweeping action of the telescopic pole) is guaranteed to always keep contact with the surface without facing the risk of de attachment. It will be appreciated that this design can be implemented with all the previous embodiments and the different joints described herein. In other words, the magnetic roller 410 is coupled to the distal end of the telescopic pole 120 which is attached at its proximal end to the body of the UGV. As mentioned, the joint or coupling between the magnetic roller 410 and the telescopic pole 120 can be a swivel joint or a ball joint (ball-in-socket).

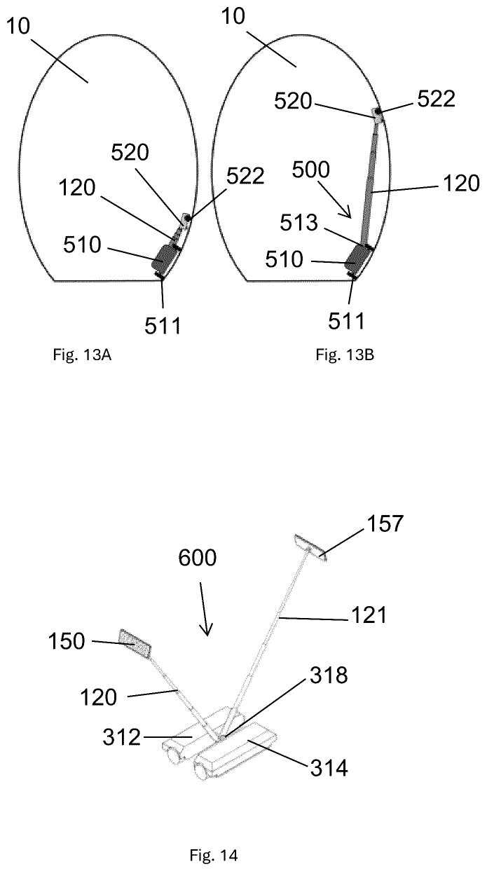

FIGS. 13A-13B illustrate a system 500 according to another embodiment and is directed to a system that includes a magnetic base station with a pushable sensor array. The system 500 includes a base station 510 that is magnetically stuck to the tank wall as by having a plurality of magnetic wheels 511. The base station 510 has a motorized pole 120 that can be expanded to push a multi sensor array 520 along the circumference of the tank. The multi sensor array 520 is equipped with magnetic wheels 522 (e.g., passive undriven rollers) similar to the previous embodiment. As shown in FIGS. 13A-B, the telescopic pole 120 actuates and extends upwards to push the multi sensor array 520 vertically and around the circumference.

The telescopic pole 120 is attached to the base station 510 via a passive joint 513 that is not motorized or controlled, unlike some of the previously disclosed embodiments. Once the circumferential scan is completed, the base station 510 can be stepped forward along the length of the tanks using the embedded magnetic wheels 511. In many scenarios, this system can do half of the tank that is closer to the base station 510, and the process would have to be repeated on the other side to cover the other half.

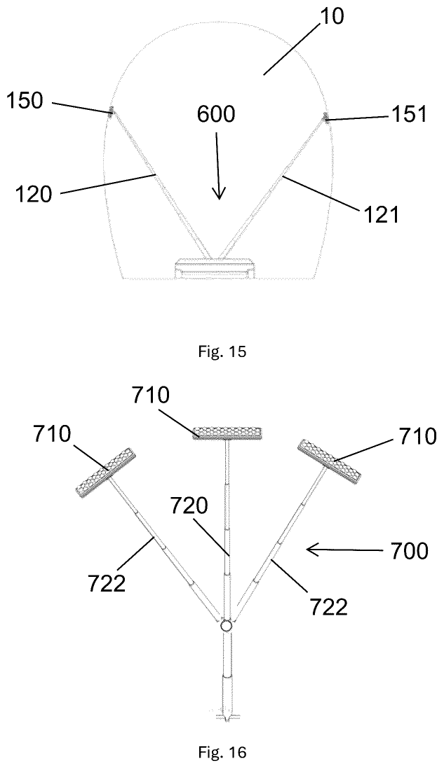

FIGS. 14-15 illustrate another system 600 that is similar to the system 300 but expands upon that embodiment by including a second telescopic pole 121 and a second multi sensor array 157. The two telescopic poles 120, 121 pivot about the same shaft 318 and are spaced apart from one another along the shaft 318. The two telescopic poles 120, 121 pivot independently from one another and thus, the two telescopic poles 120, 121 can pivot in opposite directions. This allows the robotic system 600 to send both telescopic poles 120, 121 to the opposite edges of the cavern tank and simultaneously sweeps both telescopic poles 120, 121 at the same time converging at the top of the cavern tank.

FIG. 15 shows the use of the two telescopic poles 120, 121 and the positioning of the two multi sensor arrays 150, 157 along two opposite sides of the cavern tank wall.

This method increases the efficiency of the inspection process by reducing the time it takes to conduct a sweep by half due to two independent multi sensor arrays 150, 157 scanning the two different halves of the cavern tank wall. This is also mostly beneficial in cases where there is overhead pipe running on the cavern tank roof along the length of the tank. In such a construction, with one telescopic pole 120, the operator either needs to detach the multi sensor array 150 from the tank surface everytime the pipe comes across the sweeping multi sensor array 150, or the operator needs to complete one side of the tank and then do the other side separately. Both of these operations are less than ideal. By incorporating two telescopic poles 120, 121, the operator can do two sides simultaneously without worrying about the overhead pipe running along the center of the roof of the cavern tank.

FIG. 16 illustrates another embodiment and in particular, illustrates a branched telescopic pole 700 with multiple scanning heads 710. The pole 700 includes a main pole section 720 and a plurality of pole branches 722 that protrude outwardly from the main pole section 720. In the illustrated embodiment, there are two pole branches 722 that converge and are coupled to the main pole section 720 at the same longitudinal position.

Each of the main pole section 720 and the two pole branches 722 carries one scanning head 710. Each scanning head 710 can include one or more sensors. It will also be appreciated that each scanning head 710 can have a different type of sensor (sensing mechanism) to allow for different types of NDT testing and respective data gathering while performing the sweep on the circumference of the tank.

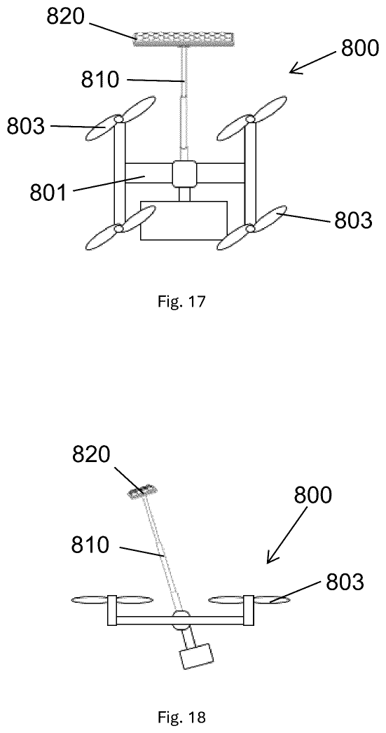

In yet another embodiment, the construction of FIG. 18 can be modified so that the telescopic poles 722 can each move independently and are attached to the main telescopic pole 720 with a pan and tilt mechanism which allows the branches 722 to rotate 360 degrees. This in turn allows the sweep of the to take a larger 2D scanning path instead of the previous 1D line path of FIG. 17.

Now turning to FIGS. 17-18 which is directed to an unmanned aerial vehicle (UAV) 800 with a telescopic pole sensor array. Instead of the UGV, the UAV 800 becomes the platform of choice to carry a telescopic pole 810 and an inspection sensor array 820. The UAV has a body 801 and is powered by a plurality of propellers 803.

Similar to the UGV, the UAV contains electronics, including a controller and communication equipment that allows the remote control over the UAV. In addition, the UAV can include vision-based equipment, such as cameras, that permit the operator to view the inspection site. This allows the system 800 to reach the target in a manner that doesn't require a long telescopic pole 120 but instead a shorter pole 810 can be used. It would also allow the telescopic pole 810 to reach areas of interest at tight angles that are not feasible if carried by a UGV. For example, reaching and inspecting the tank wall portion that is above the overhead pipes would be easier if the UAV flies to the vicinity of the overhead pipe and extend the pole to inspect the area. It would also aid in avoiding obstacles and pipes more easily. The UAV can be untethered or tethered to achieve longer flight times. Also, the battery can be mounted in a way to act as a counterbalance to the pole and sensor array in order to make the UAV flight more stable.

It will be appreciated that the embodiments disclosed herein are directed to provide a solution and a method that performs rapid scanning for the entire wall surface in order to obtain a full corrosion map quickly in a timely manner. Traditional system are typically used to perform spot checks in certain locations and don't teach about rapid scanning of the surface. In the present embodiments, the sensor head is in the form of a multi sensor array and in particular, can be an array of UT sensors (instead of a single sensor) in order to immediately obtain at every point in time a portion of the 2D corrosion map. This is in comparison to using a regular UT sensor that only captures thickness measurement at on location at every time step.

In the present embodiments, the multi sensor array is mounted on the end of the telescopic pole arm which is rapidly swept around the circumference of the surface. The arm is constantly pushed against actively (or passively via spring loading) in order to maintain good contact with the surface during the scanning. The disclosed systems deal well with non-cylindrical curved surfaces which we have in our underground tanks as visualized in the IDD. The continuous extension of the pole and the passive articulating on the array head allow the array to constantly remain in contact with the surface while the arms swings around the circumference of the tank. The telescopic pole can be electrically powered, or it can be pneumatic with internal pressure constantly pushing the head onto the surface regardless of the distance to the robot (due to the non-cylindrical tank shape). Pneumatics also provide inherent elasticity to provide a spring-like behavior while pressing the head onto the surface. A hybrid electric-pneumatic drive can also be advantageous to provide the benefit of both power delivery methods.

The autonomous system (robot) drives forward along the length of the tank in a straight line without the need to meander around the tank floor. This is again in order to achieve the fastest method possible to obtain a full scan of the wall. If the vehicle deviates a bit with a non-zero yaw angle, the sensor head still maintains full contact with the surface thanks to the articulation on the end of the telescopic pole and the two degree of freedom articulation in the base of the telescopic pole (within the body of the UGV).

Localization and sensing can be utilized to constantly measure and detect the location of the robot, the location of the head (end-effector), and the shape of the tank to actively and automatically maintain contact of the head on the surface while swinging the arm around the tank circumference.

The embodiments also deal with the common problem of overhead pipes and can still perform rapid full scanning of the surface (albeit not in the areas directly between the overhead pipe and the tank wall itself) using double arms and branched arms. This is also achievable with a single arm by quickly scanning one half of the full tank on one side of the overhead pipe, and then driving the robot back along the tank length to scan the other half on the other side of the overhead pipe.

The array can be multi-modal to capture various types of sensing data simultaneously instead of only focusing on UT corrosion mapping.

As mentioned, traditional inspection systems suffer from a number of deficiencies. Some traditional systems utilize a handheld telescopic pole mechanism to inspect assets and some traditional solutions only provide visual inspection. These systems are handheld and only offer a single type of NDT inspection mechanism. In contrast, the present systems provide a multi-sensor array. In addition, the traditional systems require operators to manually control the telescopic pole unlike the present systems which utilize different mechanisms and a UGV to obtain the NDT results.

It will also be appreciated that since the inner wall of the underground tank may be curved, the controller for the motorized telescopic pole can be configured such that the telescopic pole is extended until contact and resistance is detected. The motorization can thus be configured to extend the pole until resistance and then once resistance is detected, the pole can be maintained.

The motorized pole can be extended until contact, which can be detected via resistance or via contact or proximity-based sensors. Upon contact, the pole is swept around the circumference of the tanks via the motorized pan/tilt mechanisms actuating the pole. In order to maintain contact with the surface, it is possible to always maintain a small outward push via actuation so that while sweeping if the distance from the robot to the tank wall increases the pole will simply extend and maintain contact with the surface. A current-controlled or force-controlled pole extension motor will be able to maintain contact and as soon as contact is lost the loss of current/force/resistance will be detected and compensation extension will be provided. When the sweep is completed, either via a pre-programmed sweep angle (trajectory) or via a collision detection sensor to prevent collision with overhead pipe or any other obstacles, the vehicle steps forward, either after retracting the pole or while maintaining contact with the surface, in order to initiate the next sweep. It will be appreciated that other techniques can be used.

In addition, since the sensor head 150 can be attached to the inner wall by magnetic attraction, the movement of the motorized telescopic pole results in movement and repositioning of the sensor head along the surface. As mentioned, the telescopic pole can be moved in a sweeping action that allows the sensor head to be first located at a first position, say bottom of the wall, and then raised along the inner wall to a second position, say a top of the wall. This sweeping action is along an arcuate path.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. An autonomous system for inspecting an underground tank comprising:
an unmanned ground vehicle (UGV) that is configured to drive along an inner wall of the underground tank;
a motorized telescopic pole that is movably attached at a first end to the UGV; and
a multi sensor array that is movably attached to an opposite second end of the telescopic pole, the multi sensor array comprising a plurality of sensors for inspecting the inner wall of the underground tank.

2. The autonomous system of claim 1, wherein the plurality of sensors include ultrasonic transducers for determining a thickness of the inner wall.

3. The autonomous system of claim 2, wherein the multi sensor array comprises a sensor head in which the ultrasonic transducers are arranged in two interlaced horizontal arrays with a degree of overlap of sensor coverage to provide a wider field of inspection.

4. The autonomous system of claim 3, wherein the two interlaced horizontal arrays are configured to measure the inner wall thickness of a full line that spans an entire width of UGV.

5. The autonomous system of claim 1, wherein the plurality of sensors are selected from the group consisting of: phased array ultrasonic transducers; a holiday sensor for detecting cracks; an eddy current sensor or an array of eddy current sensors to detect cracks; electromagnetic acoustic transducer (EMAT) for thickness measurements and crack detection; sensors configured for terrahertz inspection; sensors configured for magnetic particle inspection (MPI) for crack detection; magnetic flux leakage (MFL) sensors for crack detection; and sensors configured for LIDAR scanning to inspect deformations.

6. The autonomous system of claim 1, wherein the first end of the motorized telescopic pole is attached to the UGV by a swivel joint or multi-directional joint.

7. The autonomous system of claim 6, wherein the multi-directional joint at the first end of the motorized telescopic pole comprises a ball joint that allows the motorized telescopic pole to rotate in a 360-degree manner.

8. The autonomous system of claim 1, wherein the first end of the motorized telescopic pole is attached to the UGV by a two degree of freedom pan and tilt mechanism.

9. The autonomous system of claim 1, wherein the multi sensor array is attached to the second end of the motorized telescopic pole by a multi-directional ball joint.

10. The autonomous system of claim 1, wherein the first end of the motorized telescopic pole is attached to the UGV by a cable driven multi-directional joint mechanism.

11. The autonomous system of claim 10, wherein the cable driven multi-directional joint mechanism includes a ring that is coupled to and surrounds the motorized telescopic pole, a plurality of wires, wherein first ends of the plurality of wires are attached to the ring and second ends of the plurality of wires are coupled to a plurality of independent motors, each motor being configured to wind and unwind one respective wire resulting in controlled movement of the motorized telescopic pole.

12. The autonomous system of claim 11, wherein the UGV includes a body with a plurality of wheels, the plurality of motors being located along a top surface of the body.

13. The autonomous system of claim 1, wherein the UGV includes a first body and a second body spaced apart from the first body with a gap therebetween, the motorized telescopic pole being rotatable about a shaft that extends across the gap.

14. The autonomous system of claim 13, wherein the first body has a first pair of wheels and the second body has a second pair of wheels and wherein a range of motion of the motorized telescopic pole is greater than 180 degrees.

15. The autonomous system of claim 13, further including a second motorized telescopic pole being rotatable about the shaft independent from rotation of the other motorized telescopic pole, thereby permitting sweeping action and simultaneous inspection of two opposite regions of the inner wall.

16. The autonomous system of claim 1, wherein the multi sensor array comprises a magnetic rolling sensor array that includes switchable magnetic wheels for magnetic attachment to the inner wall that comprises a metal inner wall.

17. The autonomous system of claim 1, wherein the motorized telescopic pole has a main section with a first scanning head at a distal end thereof and a plurality of branched telescopic poles that branch and extend outward from the main section, each branched telescopic pole having a scanning head at a distal end thereof.

18. The autonomous system of claim 17, wherein the plurality of branched telescopic poles comprise a second branched telescopic pole with a second scanning head at a distal end thereof and a third telescopic pole with a third scanning head at a distal end thereof.

19. The autonomous system of claim 18, wherein each of the second branched telescopic pole and the third branched telescopic pole is coupled to the main section by a joint that permits each of the second branched telescopic pole and the third branched telescopic pole to rotate 360 degrees.

20. The autonomous system of claim 1, wherein the plurality of sensors comprise two or more different sensors.

21. An autonomous system for inspecting an underground tank comprising:
an unmanned aerial vehicle (UAV) that is configured to drive along an inner wall of the underground tank;
a motorized telescopic pole that is movably attached at a first end to the UAV; and
a sensor head including a multi sensor array, the sensor head being movably attached to an opposite second end of the telescopic pole, the multi sensor array comprising a plurality of sensors for inspecting the inner wall of the underground tank.
